(19) United States
(12) Patent Application Publication
(10) Pub. No.: US 2007/0082684 A1
(43) Pub. Date: Apr. 12, 2007

(54) Method of obtaining a higher location precision of a wireless communication device

(76) Inventors: Alex Rozenstrauch, Buffalo Grove, IL (US); Dhananjay S. Joshi, Wheaton, IL (US); George V. Rykowski, Crystal Lake, IL (US)

Correspondence Address: MOTOROLA, INC., 1303 EAST ALGONQUIN ROAD, IL01/3RD, SCHAUMBURG, IL, 60196, US

(21) Appl. No.: 11/248,758

(22) Filed: Oct. 12, 2005

(51) Int. Cl. H04Q 7/20

(52) U.S. Cl. 455/456.5

(57) ABSTRACT

A method and apparatus for reducing the number of base stations used for paging a mobile station by obtaining a higher location precision of the mobile station by providing a first location update at a first location register from a wireless communication device (515, 520); sending a second location update to a second location register in response to the first location update (525, 530); and determining the location of the wireless communication device based on at least one of the first location register and the second location register (535), wherein the first location register corresponds to a first location area and the second location register corresponds to a second location area. The invention proposes to include a universal location area server (305) to perform a correlation between the first location register and a second location register to obtain the reduced set of base stations.

### FIELD OF THE INVENTION

The present invention relates generally to optimizing dual technology systems with overlying coverage and more specifically, to reducing the number of base stations used for paging a mobile station by obtaining a higher location precision of the mobile station.

### BACKGROUND OF THE INVENTION

Wireless communication systems, which enable a wireless communication device to travel while retaining the device's ongoing communication, comprise base stations situated at various locations in a geographic area. Each base station services the mobile stations within a predetermined range, the predetermined range being called a cell. A base station houses the equipment needed to set up and complete calls on the mobile stations within the base station's cell

Due to the competition among various wireless communication service providers, very often, the communication systems, which the wireless communication service providers use, provide coverage to the same geographic areas utilizing independent sets of base stations or cells. Thus, there can be overlays of communication systems used by different service providers or a service provider providing different services on the same set of base stations.

Technology migration or dual technology may require the same service provider to have overlays of different technologies to the same geographic area, for example migration from analog technology to digital technology is used in Code Division Multiple Access (CDMA) technologies and this requires the service providers to overlay different technologies in the same geographic area.

Moreover, a single communication system might provide independent service features using a same set of base stations or cells. A particular example of such a communication system is an Integrated Digital Enhanced Network (iDEN) bi-polar communication system, which utilizes a same set of cells or base stations to carve out independent sets of service areas. For example, the iDEN system has a Dispatch Location Area (DLA) for providing Push-to-talk (PTT) services and an Interconnect Location Area (ILA) for providing interconnect (phone) service. Each system service, for example a PTT or an interconnect, utilizes its own registration that is stored in a visitor location register (VLR) or a host location register (HLR) corresponding to the system service's service area, for example DLA or ILA. A location register (VLR or HLR) is essentially a database that stores information about the wireless communication devices that are currently within its service area (ILA or DLA). Thus, a mobile station, subscribing to a PTT service, registers with the DLA the device travels into and the registration is stored in the DLA's VLR. Similarly, the mobile station, subscribing to an interconnect service, registers with the ILA it travels into and the registration is stored in the ILA's VLR.

The registration of the mobile station stored in the location registers (VLRs or HLRs) of the DLA or the ILA, provides the corresponding system service (PTT or interconnect) with the information about the device's location. However, in prior art systems a VLR corresponding to the service is generally updated when the wireless communication device moves from one area of the service to another. For example, the Dispatch VLR is updated when the wireless communication device moves from one DLA to another DLA. Each system service pages the wireless communication device using the location information obtained form the VLR corresponding to the service. Hence, an excess of base stations are required to page the mobile station due to no coordination between the VLRs of different communication systems or services.

Thus, there exists a need for a method and a system to reduce the number of base stations used for paging a wireless communication device by obtaining a higher location precision of the wireless communication device.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of a Dispatch Location Area (DLA) and Interconnect Location Area (ILA) in accordance with the embodiments of the present invention.

FIG. 2 illustrates a block diagram of a device to obtain a reduced set of base stations for paging a wireless communication device in accordance with the embodiments of the present invention.

FIG. 3 illustrates a block diagram of a location server that coordinates between VLRs and assists in the determination of a reduced location for paging a wireless communication device in accordance with the embodiments of the present invention.

FIG. 4 illustrates a wireless communication device traveling through various location areas in accordance with the embodiments of the present invention.

FIG. 5 illustrates a flow diagram of a method for determining a location of a wireless communication device corresponding to a traveling mobile station in accordance with the embodiments of the present invention.

FIG. 6 illustrates a flow diagram of a method for enabling the determination of the location of a wireless communication device using an ULAS in accordance with the embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for reducing the number of base stations used for paging a wireless communication device by obtaining a higher location precision of the wireless communication device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus for reducing the number of base stations used for paging a wireless communication device by obtaining a higher location precision of the wireless communication device described herein. The non-processor circuits may include, but are not limited to, a radio receiver, a radio transmitter, signal drivers, clock circuits, power source circuits, and user input devices. As such, these functions may be interpreted as steps of a method to perform the reduction in the number of base stations used for paging a wireless communication device by obtaining a higher location precision of the wireless communication device described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the invention provides a method and a system for reducing the number of base stations used for paging a wireless communication device by obtaining a higher location precision of the target subscriber. Examples of wireless communication devices include a mobile phone, a personal digital assistant or a laptop. For example, an Integrated Digital Enhanced Network (iDEN) bi-polar communication system utilizes a same set of base stations, generally referred to in the art as cells to carve out independent sets of areas where service is provided. Such areas of service are known as location areas. Some examples for location areas include a Dispatch Location Area (DLA) providing Push-to-Talk (PTT) services and an Interconnect Location Area (ILA) providing interconnect (phone) services respectively. Therefore, a location area, for instance a single DLA can be divided into one of more cells serviced by one or more base stations.

A single base station, belonging to a DLA and an ILA, provides services to both, a DLA and an ILA. Each base station in a location area can comprise a register corresponding to the location are, such as a Visiting Location Register (VLR). The wireless communication device sends a location update to all VLRs corresponding to a new location area when the wireless communication device moves into the new location area. The VLRs can reside on each base stations servicing the new location area. For instance, the wireless communication device sends a location update to the Dispatch VLRs corresponding to a new DLA while moving into the new DLA. Similarly, the wireless communication device sends a location update to each Interconnect VLR corresponding to each base station in a new ILA when the wireless communication device moves into the new ILA. Those skilled in the art shall realize that the same method is applied for all communication systems or services, however, each communication system (for example a CDMA system and an iDEN system) utilizes separate base stations for providing their respective services possibly covering the same or partially overlapping geographical area such as a location area assuming that the wireless communication device is a dual mode communication device that is being serviced by two different communication systems and that the dual mode communication device can use either of the two communication systems to communicate with different type of base stations. It shall also be appreciated by those skilled in the art that the number of different communication systems or services providing coverage to a geographic area is not limited to two.

The intersection of the location areas, for example an intersection of an ILA and a DLA, enables a wireless communication device to page a reduced set of base stations for outgoing pages. Analogously, base stations belonging only to the intersection of the location area are used for paging the wireless communication device of the target subscriber instead of paging the base stations belonging to the complete location areas and consequently reduces the unnecessary utilization of resources. Those skilled in the art will realize that the recognized advantages and other advantages described herein are merely exemplary and are not meant to be a complete rendering of all of the advantages of the various embodiments of the present invention.

Referring now to the diagrams, and in particular FIG. 1, a block diagram of a DLA 105 and an ILA 110 is shown in accordance with the embodiments of the present invention and is indicated generally at 100. Those skilled in the art, however, will recognize and appreciate that the specifics of this illustrative example are not specifics of the invention itself and that the teachings set forth herein are applicable in a variety of alternative settings. For example, since the teachings described do not depend on the type or number of communication systems or services, they can be applied to any type or number of communication systems or services used although only two overlaying communication services are shown in this embodiment. As such, other alternative implementations of using different types of communication systems and services are contemplated and are within the scope of the various teachings described.

In an iDEN bi-polar communication system, base stations can be used to carve out independent sets of service areas, since iDEN location areas, for example DLA and ILA, are generally superimposed on each other. For instance, in accordance with the embodiment illustrated in FIG. 1, a set of cells as shown at 115, 120 and 125, generally having one base station per cell 130, 135, 140, can be a part of the location area DLA1 105 and location area ILA1 110. A base station can comprise a call controller (not shown) and a VLR (not shown) corresponding to each communication system or service provided by the base station. Cell 115 forms part of DLA1 105 as well as ILA1 110. Similarly, cells 120 and 125 form part of both, DLA1 105 and ILA1 110. Those skilled in the art shall realize that the number of base stations is not restricted in either DLA 105 or ILA 110, and is used only for explanatory purposes and the intersection of the two location areas could contain any number of base stations.

Typically, in iDEN systems, the sizes of a DLA and an ILA can differ substantially. The DLAs are normally smaller, in the range of approximately 10 to 15 base stations or cells, whereas the ILAs can be much larger, for example comprising approximately 50 to 90 base stations or cells. DLAs, for instance providing PTT service, comprise lesser number of base stations and can be smaller in size to optimize the iDEN system for frequent calls or paging load. This arrangement can avoid overloaded base stations belonging to the DLAs since PTT services might require frequent calls and paging. ILAs providing interconnect (phone) services, comprise a larger number of base stations and are generally larger in size to optimize the iDEN system for minimum location update loads assuming less frequent calling or out-bound paging.

When an iDEN enabled wireless communication device travels, it can pass through several different DLAs and ILAs depending on the kind of ongoing communication service used. For instance while utilizing a PTT service, the wireless communication device may travel through several DLAs. Each time the wireless communication device changes either a DLA or an ILA, the wireless communication device is required to register with the changed DLA or ILA. Registration may entail the wireless communication device sending, for instance, a location update to a visitor location register (VLR) residing on each base station corresponding to the changed DLA or ILA. For example, in accordance with the embodiment depicted in FIG. 1, each base station belonging to DLA1 105 and ILA1 110 can have separate VLRs corresponding to each of DLA1 105 and ILA1 110 and are generally referred to as a dispatch VLR and an interconnect VLR respectively. A VLR is, essentially, a database of all the wireless communication devices currently present in a location area corresponding to the VLR. In accordance with FIG. 1 and assuming that a wireless communication device was in a different ILA and DLA previously, the wireless communication device sends a location update to dispatch VLRs and interconnect VLRs residing on the base stations 130, 135 and 140 on entering cell 115 since a new DLA, DLA1 105, and a new ILA, ILA1 110, has been entered. Cell 115 belongs to both, the DLA1 105 and the ILA1 110, and therefore both, dispatch VLRs and interconnect VLRs, are updated. However, in conventional systems, if the wireless communication device moves into a new ILA while in the same DLA, only the interconnect VLRs of the new ILA was updated. According to an embodiment of the invention, on receiving a location update at one VLR, the VLR of another communication system or service is also updated. For instance, when the wireless communication device moves into a new DLA and updates the dispatch VLRs, the interconnect VLRs of the ILA is also updated. The dispatch VLRs and the interconnect VLRs can reside on all base stations in their respective DLAs or ILAs and the functioning of such VLRs is known in the art.

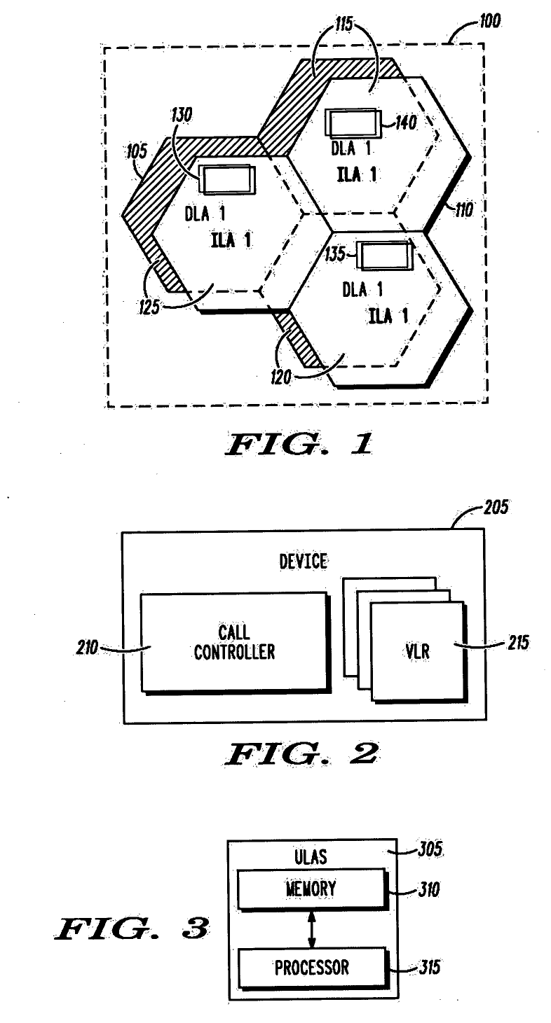

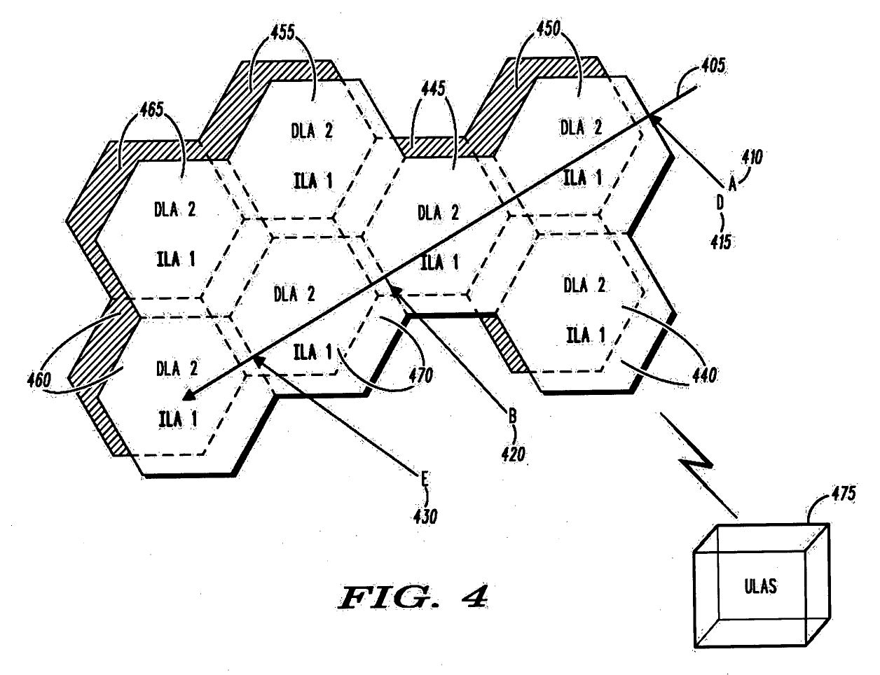

Turning now to FIG. 2, a block diagram of a device used to obtain a reduced set of base stations for paging a wireless communication device corresponding to a traveling wireless communication device is illustrated in accordance with the embodiments of the present invention. The device can be a base station 130, 135, 140 located in each cell as illustrated using FIG. 1. The device 205 generally comprises a call controller 210 and a plurality of VLRs 215 corresponding to the services provided by the device 205 and is adapted for obtaining a reduced location of the wireless communication device from a universal location area server (ULAS). Detailed functioning of the ULAS is described in FIG. 3. The call controller 210 can also perform a correlation between the location registers corresponding to the communication systems or services and determine the reduced location of the wireless communication device. The device 205 can then be configured to page the base stations belonging to the reduced location. Similarly, the wireless communication device may need to send outgoing pages to the reduced set of base stations.

In one embodiment, the call controller 210 obtains information from a first location register, for example a dispatch VLR. The Dispatch VLR can be one of the VLR's 215 located at the device 205, for instance a base station. The first location register may have received a location update from the second location register, for example an interconnect VLR or from the wireless communication device. The interconnect VLR can also be one of the VLR's 215 located at the device 205. The call controller 210 can obtain the reduced location of the wireless communication device by correlating information from the dispatch VLR and the interconnect VLR. The call controller can, also, be responsible for paging the base stations belonging to the reduced location in case of an outgoing call or for the base stations belonging to the reduced location paging the wireless communication device in case of an incoming call. Those skilled in the art shall realize that the reduced set of base stations can also be calculated at the ULAS and sent to the call controller 210.

However, in case of a delay in obtaining the information from the ULAS or the VLRs for example the interconnect VLR, the dispatch VLR, the call controller 210 can page all base stations belonging to the complete location area, for example the base stations belonging to the complete ILA or DLA. This provides a fallback mechanism to the communication system in case of a possible update delay where the call is not dropped or lost due to a delay in receiving the location of the wireless communication device. The device can be deployed within communication systems or services such as a Code Division Multiple Access (CDMA) network, Integrated Digital Enhanced Network (iDEN) network or Global System for Mobile Communication (GSM) network

Referring to FIG. 3, a block diagram of a location server 305 that coordinates between VLRs and assists in the determination of a reduced location for paging a wireless communication device is illustrated in accordance with the embodiments of the present invention. The location server 305 comprises a memory 310 operatively coupled to a processor 315 and adapted for obtaining a first location update from a first location register. The first location register can be a dispatch VLR or an interconnect VLR. The first location register can be a register corresponding to a communication service in one location area. However, those skilled in the art shall realize that since each location area can have several location registers, a location register for each base station serving the location area, updating the first location register will include updating all location registers within the location area. For example, updating a first dispatch location register can include updating all dispatch location registers within one dispatch location area. The first location update can be sent by the wireless communication device while moving between two location areas, for example a DLA or an ILA corresponding to the location registers. The location registers can be dispatch VLRs or an interconnect VLRs. When a wireless communication device moves between two DLAs, the entry corresponding to the location of the wireless communication device in the DLA, which the wireless communication device moved out of, can be removed from corresponding dispatch VLRs and an entry corresponding to the new location of the wireless communication device in the new DLA can be added to the new dispatch VLRs. As per one embodiment, the location server 305 receives the update from the first location register, for example a dispatch VLR that has been updated, and simultaneously updates a second location register, for example an interconnect VLR corresponding to an ILA where the wireless communication device is currently located.

As per one embodiment of the present invention, the location server 305 can calculate a reduced set of base stations using a call controller coupled to the location server 305. The call controller uses the updated VLRs and computes an intersection of the VLRs, which corresponds to the reduced set of base stations. For instance, an intersection of the DLA and the ILA corresponding to a Dispatch VLR and an Interconnect VLR obtained at the location server, provides the reduced set of base stations. In one embodiment of the present invention, the said location server can be a stand-alone entity known as a Universal Location Area Server (ULAS), which can be in communication with the base stations. In another embodiment of the present invention, the location server can be a part of the base station.

An embodiment depicting a wireless communication device traveling between different DLAs and ILAs and the various teachings disclosed herein are explained using FIG. 4. As stated previously, those skilled will appreciate that although the communication system (iDEN system) is shown with two types of location areas (DLA and ILA) according to this particular embodiment, the invention can cover any type of communication system and services with no restrictions on the number or type of location areas used.

Turning now to FIG. 4 illustrates a wireless communication device traveling through various location areas in accordance with the embodiments of the present invention. For ease of depiction, an interconnect location area (ILA) comprises cells 440, 445, 450, 455, 465 and 470 corresponding to interconnect location area ILA1 and a cell 460 corresponding to an interconnect location area ILA2. Similarly, the dispatch location area (DLA) comprises cells 440, 445 and 450 corresponding to dispatch location area DLA1 and cells 455, 460, 465 and 470 corresponding to dispatch location area DLA2. Each cell can be serviced by one base station (not shown) as illustrated in FIG. 1. Each base station may comprise a call controller and a plurality of VLRs corresponding to each service provided by the base station. One base station can serve more than one communication systems or services, for example dispatch and interconnect services. DLA1 overlaps a portion of the ILA1, where a same set of base stations corresponding to the cells 440, 445 and 450, service DLA1 and the portion of the ILA1. Similarly, a portion of DLA2 overlaps another portion of the interconnect location area ILA1, where a same set of base stations corresponding to the cells 455, 465 and 470, service the portion of DLA2 and the overlapped portion of the ILA1. The remaining portion of DLA2, namely the cell 460, overlaps ILA2 and the base station corresponding to the cell 460 services the DLA2 and the ILA2.

Now, consider that a wireless communication device (not shown) travels along the path 405 while switching between various location areas. For example, the travel path 405 comprises DLA1, ILA1, DLA2 and ILA2. More specifically, the wireless communication device moves through cells 450, 445, 470 and 460 serviced by base stations. DLA location updates are generated each time the DLA changes, specifically at points A 410 and B 420. Correspondingly, the ILA location updates are generated at points D 415 and E 430 where the wireless communication device enters a new ILA. Location updates are sent to VLRs corresponding to the location areas. The points A 410 and D 415 are equivalent pursuant to the embodiment depicted in FIG. 4.

As per one embodiment, dispatch VLRs can get location updates due to a change in the DLA, for instance while moving from DLA1 to DLA2. A location server as disclosed in FIG. 3, can update interconnect VLRs on receiving a location update from the dispatch VLRs. Hence, in spite of the ILA not receiving a location update since there has been no change in the ILA, the interconnect VLRs also obtains a location update from the dispatch VLRs due to change in a DLA. Using the location update information from the dispatch VLRs and the interconnect VLRs, a reduced set of base stations belonging to an intersection of the DLA and the ILA can be computed to page the wireless communication device as against a full set of base stations belonging to the complete location area. Analogously, the wireless communication device can send out-going pages to the reduced set of base stations.

For instance, on receiving an interconnect call when the wireless communication device is in DLA2 (for example in cell 455, cell 460, cell 465 or cell 470), the location update received from the dispatch VLRs while moving from DLA1 to DLA2 can provide information whereby only base stations comprising an intersection of DLA2 and ILA1 namely cells 455, 465, and 470, can be paged as opposed to cells 440, 445, 450, 455, 465, 470. Similarly, on receiving a dispatch call when the wireless communication device is in ILA2 (for example in cell 460), the location update received from the interconnect VLR while moving from ILA1 to ILA2 can provide information whereby only base stations comprising an intersection of DLA2 and ILA2, namely cell 460, can be paged as opposed to cells 455, 460,465 and 470. The intersection of the base stations can be calculated by correlating data between the VLRs of the overlapping location areas. If the wireless communication device is in DLA2, the reduced set of base stations is acquired by correlating between the dispatch VLRs of DLA2 and the interconnect VLRs of the ILA1.

In an embodiment, a location server, for example a universal area location server (ULAS) 475, which is in communication with the VLRs of various location areas, can be configured to correlate and calculate a reduced set of base stations. In another embodiment, the reduced set of base stations could also be calculated at a location server residing on the base stations where the base stations can be configured to maintain a dispatch VLR and an interconnect VLR.

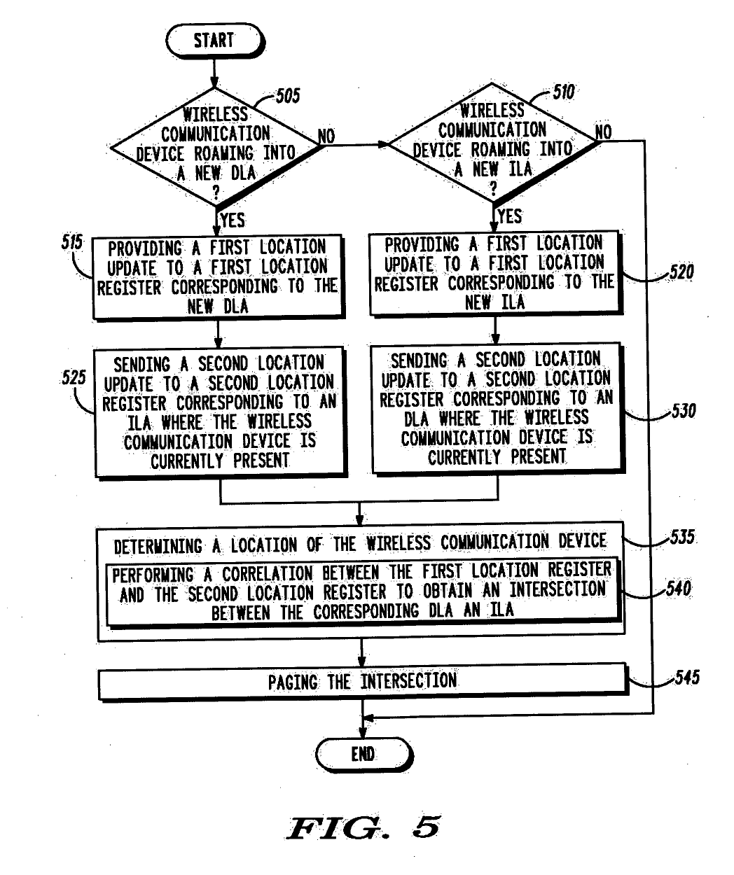

Referring now to FIG. 5, a flow diagram of a method for determining a location of a wireless communication device corresponding to a traveling wireless communication device is illustrated in accordance with the embodiments of the present invention. The method comprises the base stations detecting if the wireless communication device has moved into or moved out of a location area by receiving a location update from the wireless communication device. On detecting that the communication device has moved into a new DLA, step 505, a first location update is sent by the wireless communication device to a first location register, dispatch VLR, corresponding to the new DLA, step 515. Those skilled in the art shall realize that all the dispatch VLRs residing on their respective base stations belonging to the cells of a new DLA can receive the location update of the wireless communication device. Similarly, the wireless communication device on roaming into a new ILA, step 510 sends a first location update to the interconnect VLR, step 520. Those skilled in the art shall appreciate that this method of updating the location registers can be applied to any location areas and not necessarily only to DLAs and ILAs.

In accordance with the embodiment depicted in FIG. 4, location updates are obtained when the wireless communication device crosses the points A 410 (or D 415), B 420, and E 430 along the path 405. Thus in accordance with FIG. 4 and FIG. 5, a first location update is provided to the dispatch VLRs corresponding to the DLA1 and the interconnect VLRs corresponding to the ILA1 when the wireless communication device crosses the point A 410 or D 415 along the path 405 since the wireless communication device enters a new DLA namely DLA1, and a new ILA namely ILA1. A second location update is then sent to a second location register in response to the first location update. For instance, if the wireless communication device has changed a DLA, step 505, and hence sent a location update to the dispatch VLR corresponding to the new DLA, step 515, the second location update can be an update sent to a second location register, for example an interconnect VLR, corresponding to an ILA where the wireless communication device is located, step 525. The second location update can also be sent to a plurality of second location registers, for example a plurality of interconnect VLRs residing on their respective base stations, the base stations belonging to an ILA where the communication device is located. Similarly, a dispatch VLR is updated with a second location update in response to an update received at an interconnect VLR, step 530. The second location update informs a VLR, for example a dispatch VLR or an interconnect VLR, about an updated location of the wireless communication device. Those skilled in the art shall realize that the second location register relates to a different mode of communication than the first location register.

Referring to FIG. 4, when the wireless communication device crosses the point A 410 or the point D 415, a first location update is sent to the interconnect VLRs of ILA1 and the dispatch VLRs of DLA1. The dispatch VLRs of DLA1, further, sends a second location update of the wireless communication device to the interconnect VLRs of the ILA1. Moreover, referring back to FIG. 4, when the wireless communication device crosses the point B 420, a first location update is provided to the dispatch VLRs of DLA2 but not to the interconnect VLRs of ILA1 since the wireless communication device is still located in the same ILA namely ILA1. However, the interconnect VLRs of the ILA1 receives a second location update from the dispatch VLRs of the DLA2 in spite of the wireless communication device being in the same ILA, namely ILA1 thereby providing a higher precision of the location of the wireless communication device. Similarly, when the wireless communication device crosses the point E 430 (moves into cell 460), a first location update is provided to an interconnect VLR of ILA2 since the wireless communication device moved from ILA1 to ILA2, but no location update is give to the dispatch VLRs since the wireless communication device is still located in the same DLA, namely DLA2. However, the interconnect VLR of the ILA2 sends a second location update to the dispatch VLRs of DLA2 in spite of the wireless communication device being in the DLA, namely DLA2.

The second location register, for example a dispatch VLR or an interconnect VLR, that receives the second location update, then, determines the location of the wireless communication device at step 535. The determining step further comprises performing a correlation between the first location register and the second location register, step 540. This correlation can be performed by the device described in FIG. 2 residing on a base station. Referring to FIG. 4, when the wireless communication device crosses the point B 420 and moves into cell 470, the first location register can be the dispatch VLR of DLA2 since the dispatch location area has changed. The second location register that is updated in response to the update received by the first location register can be the interconnect VLR of the ILA1. The reduced location can, then, be determined by correlating the dispatch VLRs of DLA2 and the interconnect VLRs of ILA1 and finding the intersection of the DLA2 and the ILA1. The intersection comprises the cells 455, 465 and 470. Thus, only this reduced set of base stations belonging to the intersection has to be paged, step 545, when the wireless communication device is located in the intersection of the DLA2 and the ILA1 instead of paging the whole set of base station, 440, 445, 450, 455, 465 and 470, belonging to ILA1. Also, when the wireless communication device crosses the point E 430, the first location register which gets updated by a first location update is the interconnect VLR of ILA2 and the second location register is a dispatch VLR of DLA2. The reduced location determined in this case is the cell 460 since it belongs to both the DLA2 and the ILA2. Consequently, whenever a dispatch call is placed for the wireless communication device when it is located in the intersection, cell 460, of DLA2 and ILA2, only the base stations corresponding to the cell 460 are paged instead of paging all the base stations belonging to DLA2, namely the base stations in the cells 455, 460, 465 and 470. The wireless communication device can only page the reduced set of base stations for all outgoing pages.

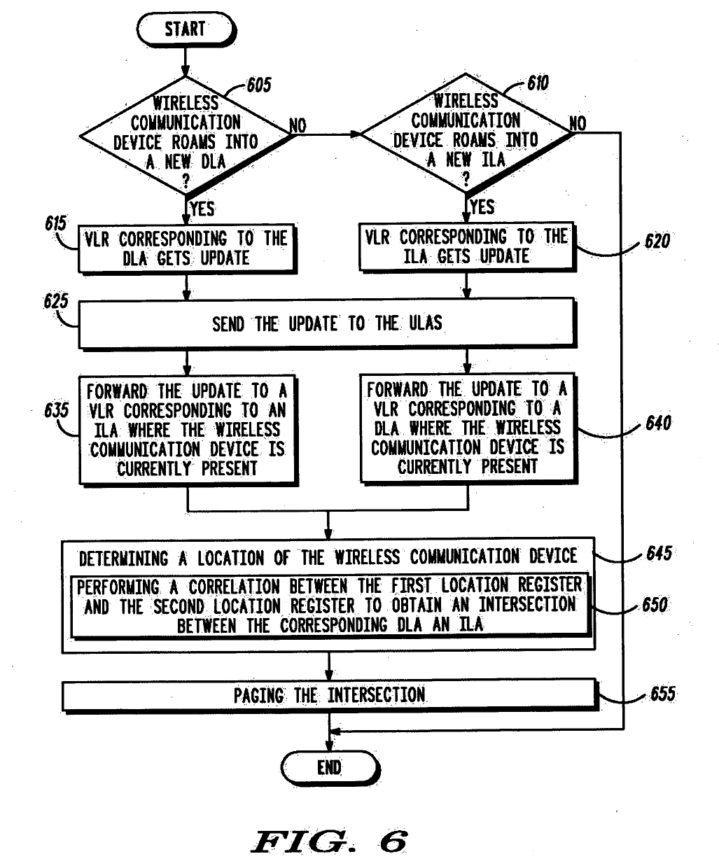

Turning now to FIG. 6, a flow diagram of a method for enabling the determination of the location of a wireless communication device using an ULAS is illustrated in accordance with the embodiments of the present invention. When the wireless communication device enters a new location area, for example a DLA or an ILA, it sends its location update to the VLRs corresponding to the new location area, for example dispatch VLRs or interconnect VLRs. For example, if the wireless communication device enters a new DLA, step 605, the dispatch VLRs corresponding to the new DLA get updated, step 615. Similarly, if the wireless communication device enters a new ILA, step 610, the interconnect VLRs corresponding to the ILA get updated, step 620.

The VLRs that have received the location update, sends the update to the Universal Location Area Server (ULAS), step 625. The ULAS can be responsible for forwarding the location update to the other VLRs. For example, if an update is sent to the ULAS form the dispatch VLRs corresponding to a DLA, the ULAS forwards the update to the interconnect VLRs corresponding to an ILA, where the communication device is currently present, step 635. Similarly, if an update is sent to the ULAS form the interconnect VLRs corresponding to an ILA, the ULAS forwards the update to the, dispatch VLRs corresponding to a DLA, where the communication device is currently present, step 640. The Universal Location Area Server (ULAS) can send the location update to the VLRs using a Wide Area Network (WAN). The updates enable the determination of a reduced location of the wireless communication device, step 645. The determination comprises performing a correlation between the first location register and the second location register to obtain an intersection between the corresponding location areas, for example a DLA and an ILA, step 650. The correlation can be performed by the ULAS described in FIG. 3. The correlation includes computing a set of base stations belonging to an intersection of two location areas, for example a DLA and an ILA. An algorithm residing either at the ULAS or at the call controller 210 of the device 205 in FIG. 2 can be used for performing the correlation and computing the reduced set of base stations. Only the base stations belonging to this intersection are paged, step 655, when the wireless communication device is located in the intersection of the two location areas, instead of paging a whole set of base stations belonging to the complete location area. Similarly, the wireless communication device can page the reduced set of base stations while sending outbound pages, for example sending a dispatch page to another wireless communication device. The present invention also provides a fallback mechanism where all cells can be paged in case of a delay in receiving an update from the location registers or the ULAS. The present invention, thus, facilitates reduction in the utilization of resources (for example base stations that are required to page the wireless communication device) and consequently making a communication system or service more optimum.

The forgoing method and system described for obtaining a reduced set of base stations, wherein dual technologies (PTT service and interconnect service) are used by the same communication system (iDEN system) in a geographic area, could also be applied to situations when two different communication systems are providing coverage to the same geographic area, for example a CMDA system and an iDEN system providing coverage to a same geographic area. When a CDMA mobile station (CDMA MS) enters a new zone (the term ‘zone’ in a CDMA system is analogous to the term ‘location area’ in an iDEN system), a registration of the CDMA wireless communication device with the zone is required in order to retain CDMA MS's communication in the new zone. Those skilled in the art shall realize that in some cases iDEN and CDMA systems are superimposed. Thus, a reduction in the number of base stations required to page a target subscriber can be established by cross-correlation of data between the VLRs of the CDMA zones and the VLRs of the iDEN location areas. However, each communication system, for example and iDEN system or a CDMA system, utilizes its own separate base stations possibly covering the same or partially overlapping geographical area. For example, a single cell can comprise different base stations corresponding to different communication systems. Analogous to the method described previously, wherein an overlay of different communication services on the same geographic area exists, in this case outbound pages can be sent to a reduced set of base stations belonging to an intersection of iDEN location areas and CDMA zones.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for determining a location of a wireless communication device, the method comprising:
providing a first location update to a first location register from the wireless communication device;
sending a second location update to a second location register in response to the first location update; and
determining the location of the wireless communication device based on at least one of the first location register and the second location register.

2. The method of claim 1, wherein the second location update is sent to the second location register using a location area server.

3. The method of claim 1, wherein the first location register corresponds to at least one of an interconnect location register and a dispatch location register, the interconnect location register corresponding to an interconnect location area and the dispatch location register corresponding to the dispatch location area.

4. The method of claim 1, wherein the second location register corresponds to at least one of an interconnect location register and a dispatch location register, the interconnect location register corresponding to an interconnect location area and the dispatch location register corresponding to the dispatch location area.

5. The method of claim 1, wherein the wireless communication device is registered with at least one of the first location register and the second location register.

6. The method of claim 1, further comprising:
performing a correlation between the first location register and the second location register to obtain an intersection between a first location area corresponding to the first location register and a second location area corresponding to the second location register, the intersection is the location of the wireless communication device.

7. A device comprising:
a call controller being adapted for:
performing a correlation between a first location register and a second location register to obtain an intersection between a first location area corresponding to the first location register and a second location area corresponding to the second location register, the intersection being the reduced location of the wireless communication device; and
paging the reduced location of the of the wireless communication device.

8. The device of claim 7, wherein the device is further adapted for paging a complete location in case of a delay in receiving the reduced location of the wireless communication device.

9. The device of claim 7, wherein the first location register corresponds to at least one of an interconnect location register and a dispatch location register, the interconnect location register corresponding to an interconnect location area and the dispatch location register corresponding to the dispatch location area.

10. The device of claim 7, wherein the second location register corresponds to at least one of an interconnect location register and a dispatch location register, the interconnect location register corresponding to an interconnect location area and the dispatch location register corresponding to the dispatch location area.

11. The device of claim 7, wherein the device is deployed within at least one of a Code Division Multiple Access (CDMA) network, Integrated Digital Enhanced Network (iDEN) network and Global System for Mobile Communication (GSM) network.

12. A location server, the location server comprising:
a memory
a processor operatively coupled to the memory and adapted for:
obtaining a first location update from a first location register, the first location update being sent by a wireless communication device; and
sending a second location update to a second location register in response to the first location update.

13. The location server of claim 12, wherein the second location register corresponds to at least one of an interconnect location register and a dispatch location register, the interconnect location register corresponding to an interconnect location area and the dispatch location register corresponding to the dispatch location area.

14. The location server of claim 12, wherein the first location register corresponds to at least one of an interconnect location register and a dispatch location register, the interconnect location register corresponding to an interconnect location area and the dispatch location register corresponding to the dispatch location area.

15. The location server of claim 12, wherein a call controller performs a correlation between the first location register and the second location register to obtain an intersection between a first location area corresponding to the first location register and a second location area corresponding to the second location register.

16. The location server of claim 12, wherein the location server is a part of a base station.

17. The location server of claim 12, wherein the location server is in communication with a base station.
